(19) United States
(12) Patent Application Publication
(10) Pub. No.: US 2013/0027798 A1
(43) Pub. Date: Jan. 31, 2013

(54) HYDRATION CONTROLLED VARIABLE REFLECTIVITY COATINGS

(71) Applicant: Empire Technology Development, LLC, Wilmington, DE (US)

(72) Inventor: Seth Miller, Englewood, CO (US)

(73) Assignee: Empire Technology Development, LLC, Wilmington, DE (US)

(21) Appl. No.: 13/647,003

(22) Filed: Oct. 8, 2012

Related U.S. Application Data
(63) Continuation of application No. 13/140,046, filed on Jun. 16, 2011.

(51) Int. Cl. G02B 5/26; B05D 5/00; B05D 1/36

(52) U.S. Cl. 359/883; 427/402

(57) ABSTRACT

Coatings configured to change between a relatively higher reflectivity state and a relatively lower reflectivity state depending at least partially upon a hydration state of at least a portion of the coating are generally disclosed. Some example coatings may include a selectively reflective layer comprising superabsorbent particles. The superabsorbent particles may have a relatively higher reflectively when substantially dry and a relatively lower reflectivity when substantially hydrated. When substantially dry, the selectively reflective layer may reflect a first fraction of incident light. When substantially hydrated, the selectively reflective layer may reflect a second fraction of the incident light. The first fraction of the incident light may be greater than the second fraction of the incident light.

### BACKGROUND

The present disclosure generally pertains to coatings and, more particularly, to coatings that may vary in reflectivity based at least in part upon hydration states of the coatings.

### SUMMARY

Coatings are generally disclosed. Some example embodiments may include methods, apparatus, and/or systems pertaining to coatings that may be configured to change their ability to transmit and/or reflect light in response to changes in hydration state. For example, some embodiments according to the present disclosure may pertain to coatings for surfaces, such as surfaces of structures, that may vary in reflectivity based at least in part upon hydration state.

Some example coatings according to the present disclosure may be configured to change between a relatively higher reflectivity state and a relatively lower reflectivity state depending at least partially upon a hydration state of at least a portion of the coating. Some example coatings may include a selectively reflective layer comprising superabsorbent particles. The superabsorbent particles may have a relatively higher reflectively when substantially dry and a relatively lower reflectivity when substantially hydrated. When substantially dry, the selectively reflective layer may reflect a first fraction of incident light. When substantially hydrated, the selectively reflective layer may reflect a second fraction of the incident light. The first fraction of the incident light may be greater than the second fraction of the incident light.

Some example methods according to the present disclosure may pertain to applying a selectively reflective coating. Some example selectively reflective coatings may be configured to change between a relatively higher reflectivity state and a relatively lower reflectivity state depending at least partially upon a hydration state of at least a portion of the coating. Some example methods may include applying a selectively reflective layer on a generally light-absorbent base layer. The selectively reflective layer may include superabsorbent particles disposed between a source of incident light and the generally light-absorbent base layer. The superabsorbent particles may have a relatively higher reflectively when substantially dry and a relatively lower reflectivity when substantially hydrated. When substantially dry, the selectively reflective layer may reflect a first fraction of the incident light. When substantially hydrated, the selectively reflective layer may reflect a second fraction of the incident light. The first fraction of the incident light may be greater than the second fraction of the incident light.

Some example selectively reflective construction materials according to the present disclosure may be configured to change between a relatively higher reflectivity state and a relatively lower reflectivity state depending at least partially upon a hydration state of at least a portion of the material. Some example construction materials may include a base layer including a generally light-absorbent surface. A selectively reflective layer including superabsorbent particles may be disposed on the generally light-absorbent surface between a source of incident light and the generally light-absorbent surface. The superabsorbent particles may have a relatively higher reflectively when substantially dry and a relatively lower reflectivity when substantially hydrated. When substantially dry, the selectively reflective layer may reflect a first fraction of the incident light. When substantially hydrated, the selectively reflective layer may reflect a second fraction of the incident light. The first fraction of the incident light may be greater than the second fraction of the incident light.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is a cross-sectional view of an example hydration-controlled coating in a substantially hydrated state;

FIG. 2 is a cross-sectional view of an example hydration-controlled coating in a substantially dry state;

FIG. 3 is an elevation view of a structure including example hydration-controlled coatings;

FIG. 4 is a flow chart illustrating an example method of applying a coating; all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

Methods, systems, devices, and/or apparatus pertaining to coatings that may be configured to change their ability to transmit and/or reflect light in response to changes in hydration state are generally described. Some example embodiments according to the present disclosure may pertain to coatings for surfaces, such as surfaces of structures, that may vary in reflectivity based at least in part upon hydration state.

Some example coatings according to the present disclosure may be configured to change between a relatively higher reflectivity state and a relatively lower reflectivity state depending at least partially upon a hydration state of at least a portion of the coating. Some example coatings may include a selectively reflective layer including a plurality of superabsorbent particles that may have a relatively higher reflectively when substantially hydrated and/or a relatively lower reflectivity when substantially dry.

Some example coatings according to the present disclosure may be used on structures, such as buildings. For example, some coatings according to the present disclosure may be used as an exterior coating for a building. Some example coatings may change from a generally rough (matte) finish to a generally smooth finish in response to the presence of water. The matte finish may reflect relatively more incident light than the generally smooth finish. Water may be applied to the coating at the beginning of the cold season (e.g., either manually, or by waiting for rain), which may hydrate the coating. While the ambient temperature is low, the coating may remain in the generally smooth (hydrated) state, which may reflect relatively less light, thereby allowing relatively more solar heating of the building. When the ambient temperature is high, water may evaporate from the coating, thereby transforming the coating to the more reflective, matte finish, which may allow relatively less solar heating. Thus, some example coatings may be used to reduce heating and/or cooling costs for the building.

As used herein, “reflectivity” may refer to the fraction of incident light that is reflected by a surface. In some example embodiments according to the present disclosure, a change in hydration state of at least a portion of a coating may produce a change in the reflectivity of the coating.

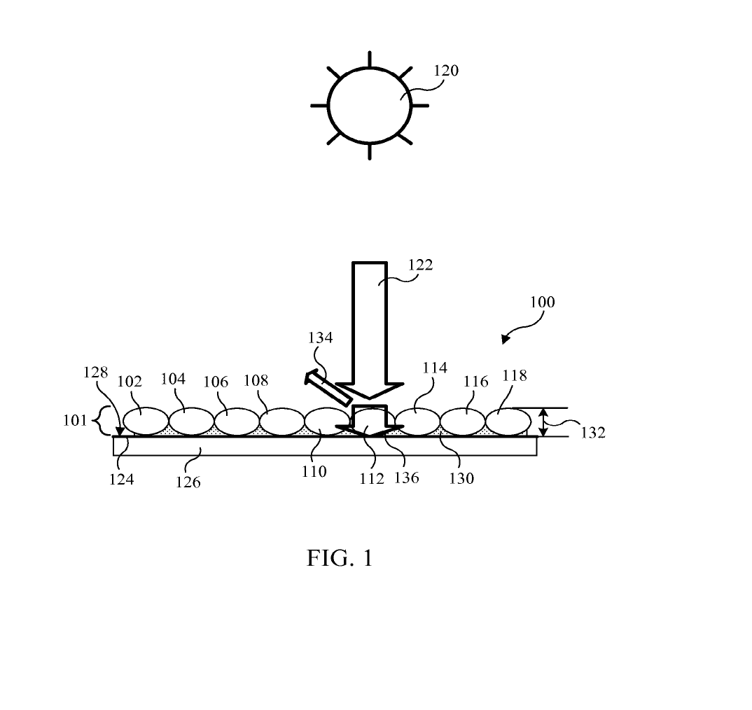

FIG. 1 is a cross-sectional view of an example hydration-controlled coating 100 in a substantially hydrated state, in accordance with at least some embodiments of the present disclosure. Coating 100 may comprise a selectively reflective layer 101, which may comprise a plurality of superabsorbent particles 102, 104, 106, 108, 110, 112, 114, 116, 118. Selectively reflective layer 101 may be disposed between a source 120 of incident light 122 and a base layer 124, which may be provided on a substrate 126. For example, selectively reflective layer 101 may be disposed on base layer 124, which may include a generally light-absorbent surface 128. In some example embodiments, superabsorbent particles 102, 104, 106, 108, 110, 112, 114, 116, 118 may be adhered to each other and/or to base layer 124 by a binder 130, which may be substantially transparent.

Coating 100 may have a thickness 132. In some example embodiments according to the present disclosure, thickness 132 may be about 100 μm to about 5 mm. In some example embodiments, thickness 132 may be about 500 μm to about 1 mm. In some example embodiments, individual superabsorbent particles 102, 104, 106, 108, 110, 112, 114, 116, 118 may be about 100 μm to about 1 mm in size. In some example embodiments, individual superabsorbent particles 102, 104, 106, 108, 110, 112, 114, 116, 118 may be about 100 μm to about 200 μm in size. In some example embodiments, superabsorbent particles 102, 104, 106, 108, 110, 112, 114, 116, 118 and/or binder 130 may be generally resistant to deterioration by sunlight (e.g., ultra-violet light).

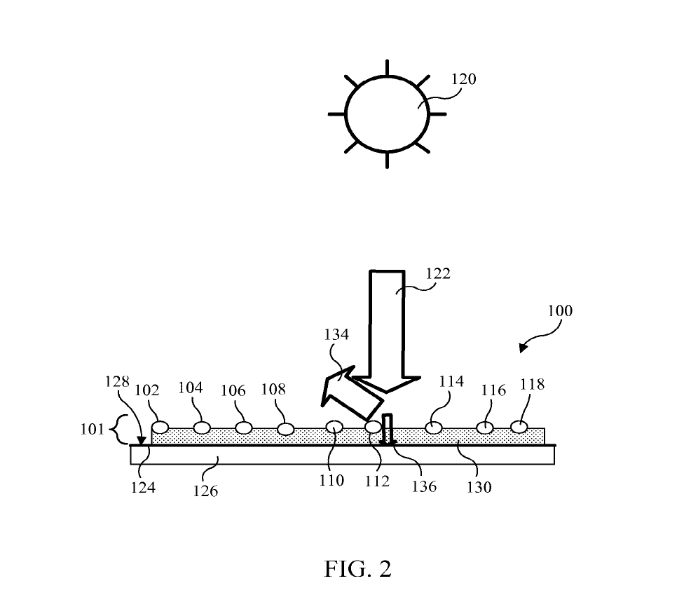

In some example embodiments, superabsorbent particles 102, 104, 106, 108, 110, 112, 114, 116, 118 may comprise superabsorbent polymer (SAP) particles, which may comprise polymers that can absorb and/or retain large amounts of a liquid relative to their own mass. For example, individual superabsorbent particles 102, 104, 106, 108, 110, 112, 114, 116, 118 may comprise sodium polyacrylate, polyacrylamide copolymer, ethylene maleic anhydride copolymer, cross-linked carboxymethylcellulose, polyvinyl alcohol copolymers, cross-linked polyethylene oxide, and/or starch grafted copolymer of polyacrylonitrile. The plurality of superabsorbent particles 102, 104, 106, 108, 110, 112, 114, 116, 118 may comprise a generally light-scattering powder providing a generally matte appearance when substantially dry (see, e.g., FIG. 2) and/or may comprise a generally transparent gel when substantially hydrated. When substantially hydrated, superabsorbent particles 102, 104, 106, 108, 110, 112, 114, 116, 118 may expand, thereby reducing the roughness of selectively reflective layer 101, converting it to a generally smooth finish. In some example embodiments, the hydration state of superabsorbent particles 102, 104, 106, 108, 110, 112, 114, 116, 118 may be at least partially dependent upon the ambient temperature. Accordingly, a reduction in reflectivity due to hydration of coating 100 on a hot day (e.g., due to a summer rain shower) may be short-lived because warm temperatures may tend to return coating 100 to its dry state.

Incident light 122 from source 120 (e.g., the sun) may strike coating 100. Coating 100 may reflect a fraction 134 of the incident light 122 and/or may transmit at least a portion 136 of incident light 122 to base layer 124. When superabsorbent particles 102, 104, 106, 108, 110, 112, 114, 116, 118 are substantially hydrated, selectively reflective layer 101 may present a generally smooth appearance, which may have a relatively lower reflectivity than the appearance presented when superabsorbent particles 102, 104, 106, 108, 110, 112, 114, 116, 118 are substantially dry. In some example embodiments, when superabsorbent particles 102, 104, 106, 108, 110, 112, 114, 116, 118 are substantially hydrated, fraction 134 of incident light 122 that is reflected by selectively reflective layer 101 may be less than about 50%. In some example embodiments, when superabsorbent particles 102, 104, 106, 108, 110, 112, 114, 116, 118 are substantially hydrated, fraction 134 of incident light 122 that is reflected by selectively reflective layer 101 may be less than about 20%.

FIG. 2 is a cross-sectional view of example hydration-controlled coating 100 in a substantially dry state, in accordance with at least some embodiments of the present disclosure. As discussed above, in the substantially dry state, superabsorbent particles 102, 104, 106, 108, 110, 112, 114, 116, 118 may comprise a generally light-scattering powder. When superabsorbent particles 102, 104, 106, 108, 110, 112, 114, 116, 118 are substantially dry, selectively reflective layer 101 may present a generally rough appearance, which may have a relatively higher reflectivity than the appearance presented when superabsorbent particles 102, 104, 106, 108, 110, 112, 114, 116, 118 are substantially hydrated. In some example embodiments, when superabsorbent particles 102, 104, 106, 108, 110, 112, 114, 116, 118 are substantially dry, fraction 134 of incident light 122 that is reflected by selectively reflective layer 101 may be at least about 50%. In so [symbol] ents, when superabsorbent particles 102, 104, 106, 108, 110, 112, 114, 116, 118 are substantially dry, fraction 134 of incident light 122 that is reflected by selectively reflective layer 101 may be at least about 80%.

In some example embodiments, substrate 126 may be generally thermally conductive. In some example embodiments, base layer 124 may be generally dark in color. Base layer 124 may comprise paint, which may be brushed, sprayed, and/or rolled onto substrate 126. Similarly, in some example embodiments, selectively reflective layer 101 may be brushed, sprayed, and/or rolled onto base layer 124.

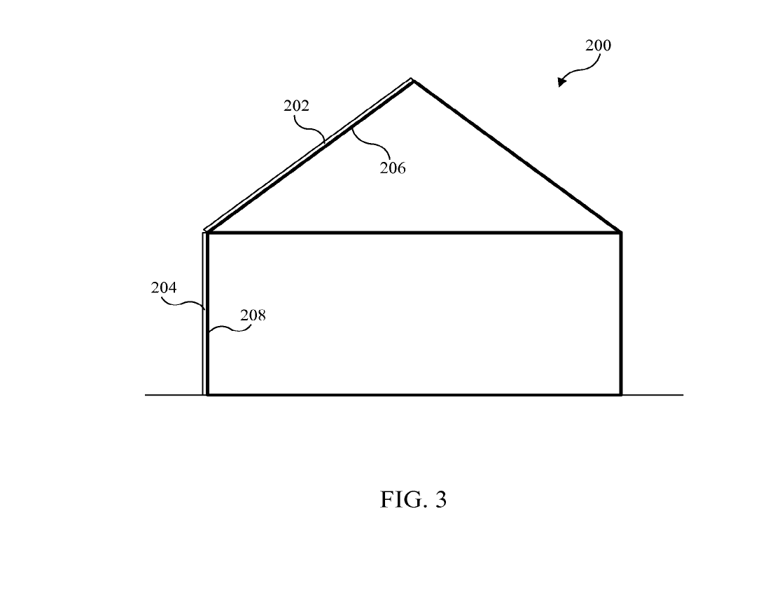

FIG. 3 is an elevation view of a structure 200 including example hydration-controlled coatings 202, 204, in accordance with at least some embodiments of the present disclosure. Some example coatings 202 according to the present invention may be disposed on and/or comprise a roofing material 206 of structure 200. Some example coatings 204 according to the present disclosure may be disposed on and/or may comprise a part of a wall covering material 208 of structure 200. Roofing material 206, wall covering material 208, and/or other materials used to construct structures may be referred to as construction materials.

In some example embodiments according to the present disclosure, roofing material 206 and/or wall covering material 208 may comprise a substrate (e.g., generally similar to substrate 126). In some example embodiments, roofing material 206 (e.g., a metal roofing material) and/or wall covering material 208 may be installed on structure 200 after coatings 202, 204 have been at least partially applied to roofing material 206 and/or wall covering material 208. For example, roofing material 206 and/or wall covering material 208 may be installed on structure 200 after a generally light-absorbent base layer has been applied to the substrate and/or after a selectively reflective layer has been applied to the base layer.

In some example embodiments, roofing material 206 and/or wall covering material 208 may be installed on structure 200 before coatings 202, 204 have been fully applied to roofing material 206 and/or wall covering material 208. For example, roofing material 206 and/or wall covering material 208 may be installed on structure 200 before a generally light-absorbent base layer has been applied to the substrate and/or before a selectively reflective layer has been applied to the base layer.

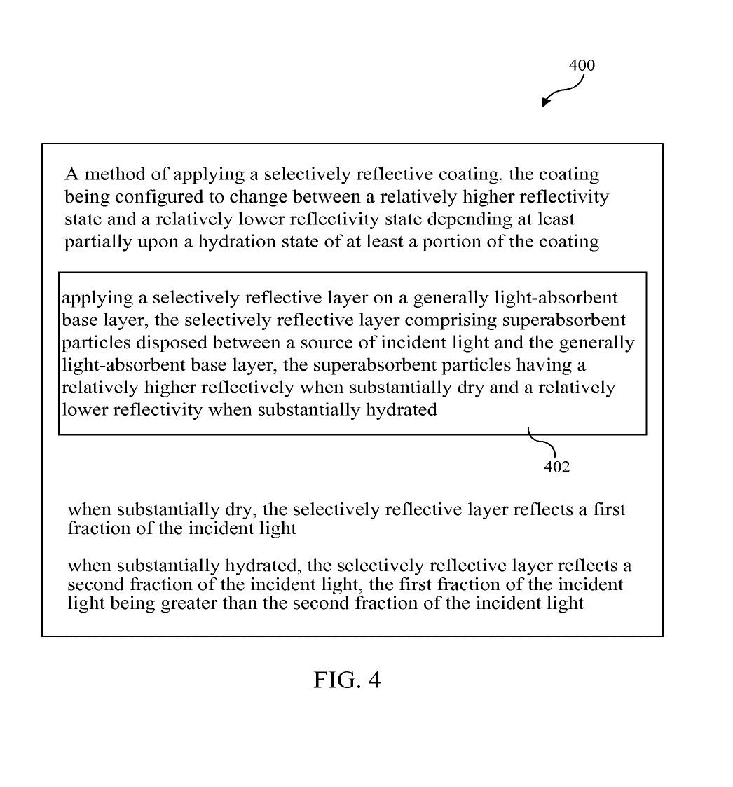

FIG. 4 is a flow chart illustrating an example method 400 of applying a coating, in accordance with at least some embodiments of the present disclosure. The coating may be configured to change between a relatively higher reflectivity state and a relatively lower reflectivity state depending at least partially upon a hydration state of at least a portion of the coating. Method 400 may include operation 402, which may include applying a selectively reflective layer on a generally light-absorbent base layer, the selectively reflective layer comprising superabsorbent particles disposed between a source of incident light and the generally light-absorbent base layer, the superabsorbent particles having a relatively higher reflectively when substantially dry and a relatively lower reflectivity when substantially hydrated. In some example embodiments, when substantially dry, the selectively reflective layer may reflect a first fraction of the incident light. In some example embodiments, when substantially hydrated, the selectively reflective layer may reflect a second fraction of the incident light. In some example embodiments, the first fraction of the incident light may be greater than the second fraction of the incident light.

Some example coatings according to the present disclosure may allow some characteristics (e.g., color, texture, etc.) of a substrate to be visible through the coating. Generally, the visible appearance of some example coatings may be dependent primarily upon the underlying base layer. In some example embodiments, the exact hue and/or pattern of the building's surface may be selected by the building's architect while retaining the selectively reflective features of the coating.

Some example coatings according to the present disclosure may be applied to and/or may comprise parts of buildings besides wall covering materials and/or roofing materials. For example, some example coatings may be applied to and/or may comprise windows, skylights, and/or other similar construction materials. Further, some example coatings according to the present disclosure may be applied to and/or may comprise parts of vehicles (e.g., automobiles, boats, trains, etc.), such as wall covering materials, roofing materials, and/or window materials for vehicles.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1-21. (canceled)

22. A hydration controlled variable reflectivity coating configured for use on
an exterior of a building or vehicle, comprising:
a base layer that includes a paint;
a selectively reflective layer including a plurality of superabsorbent particles, the selectively reflective layer disposed on the base layer; and
a binder adhered to one or more of the base layer or the plurality of superabsorbent particles,
wherein a change in a hydration state of at least a portion of the hydration controlled coating produces a change in a reflectivity of the hydration controlled coating.

23. The hydration controlled variable reflectivity coating of claim 22, wherein the hydration controlled coating is configured to change between a relatively higher reflectivity state and a relatively lower reflectivity state depending at least partially upon the hydration state of at least a portion of the hydration controlled coating.

24. The hydration controlled variable reflectivity coating of claim 22, wherein the plurality of superabsorbent particles comprise one or more of: a sodium polyacrylate, a polyacrylamide copolymer, an ethylene maleic anhydride copolymer, a cross-linked carboxymethylcellulose, a polyvinyl alcohol copolymer, a cross-linked polyethylene oxide, or a starch grafted copolymer of polyacrylonitrile.

25. The hydration controlled variable reflectivity coating of claim 22, wherein the hydration controlled coating in a substantially hydrated state has a thickness from about 100 μm to about 5 mm.

26. The hydration controlled variable reflectivity coating of claim 22, wherein the plurality of superabsorbent particles in a substantially hydrated state include individual superabsorbent particles between about 100 μm and about 1 mm in size.

27. The hydration controlled variable reflectivity coating of claim 22, wherein the base layer is brushed, sprayed, or rolled.

28. The hydration controlled variable reflectivity coating of claim 22, wherein the selectively reflective layer is brushed, sprayed, or rolled onto the base layer.

29. A coated construction material configured for use on an exterior of a building or vehicle, comprising:
a construction material substrate configured for use on an exterior of a building or vehicle;
a base layer that includes a paint;
a selectively reflective layer including a plurality of superabsorbent particles, the selectively reflective layer disposed on the base layer; and
a binder adhered to one or more of the base layer or the plurality of superabsorbent particles,
wherein:
the base layer, the selectively reflective layer, and the binder collectively form a hydration controlled coating on the construction material substrate; and
a change in a hydration state of at least a portion of the hydration controlled coating produces a change in a reflectivity of the hydration controlled coating.

30. The coated construction material of claim 29, wherein the construction material substrate includes a roofing material, a wall covering material, a window material, or a skylight material.

31. The coated construction material of claim 30, wherein the construction material substrate includes a metal roofing material.

32. The coated construction material of claim 29, wherein the hydration controlled coating is configured to change between a relatively higher reflectivity state and a relatively lower reflectivity state depending at least partially upon the hydration state of at least a portion of the hydration controlled coating.

33. The coated construction material of claim 29, wherein the plurality of superabsorbent particles comprise one or more of: a sodium polyacrylate, a polyacrylamide copolymer, an ethylene maleic anhydride copolymer, a cross-linked carboxymethylcellulose, a polyvinyl alcohol copolymer, a cross-linked polyethylene oxide, or a starch grafted copolymer of polyacrylonitrile.

34. The coated construction material of claim 29, wherein the hydration controlled coating in a substantially hydrated state has a thickness from about 100 μm to about 5 mm.

35. The coated construction material of claim 29, wherein the plurality of superabsorbent particles in a substantially hydrated state include individual superabsorbent particles between about 100 μm and about 1 mm in size.

36. The coated construction material of claim 28, wherein the selectively reflective layer is disposed between a source of incident light and a light-absorbent surface of the base layer.

37. The coated construction material of claim 29, wherein one or more of the base layer or the selectively reflective layer is brushed, sprayed, or rolled.

38. A method of applying a hydration controlled coating configured for use on an exterior of a building or vehicle, comprising:
providing a base layer that includes a paint on a construction material substrate, the construction material substrate configured for use on an exterior of a building or vehicle; and
applying a selectively reflective layer and a binder on the base layer, the selectively reflective layer including a plurality of superabsorbent particles, such that the binder adheres to one or more of the base layer or the plurality of superabsorbent particles,
wherein a change in a hydration state of at least a portion of the hydration controlled coating produces a change in a reflectivity of the hydration controlled coating.

39. The method of claim 38, further comprising disposing the selectively reflective layer on a light-absorbent surface of the base layer.

40. The method of claim 38, wherein providing the base layer on the construction material substrate further comprises brushing, spraying, or rolling the base layer onto the construction material substrate.

41. The method of claim 38, wherein applying the selectively reflective layer further comprises brushing, spraying, or rolling.

42. The method of claim 38, wherein providing the base layer on the construction material substrate further comprises installing the construction material substrate on a structure before or after applying the selectively reflective layer on the base layer.
